(19) United States
(12) Patent Application Publication
(10) Pub. No.: US 2020/0045375 A1
(43) Pub. Date: Feb. 6, 2020

(54) VIDEO PLAYBACK IN A WEB-APPLICATION USING A RESIZABLE AND REPOSITIONABLE WINDOW

(71) Applicant: salesforce.com, inc., San Francisco, CA (US)

(72) Inventors: Katherine AUGUSTUS, III, San Francisco, CA (US); Pragya ANAND, San Francisco, CA (US); Evan TSAO, San Francisco, CA (US); Sameer SETHI, San Francisco, CA (US); Raymon SUTEDJO-THE, San Francisco, CA (US)

(73) Assignee: salesforce.com, inc., San Francisco, CA (US)

(21) Appl. No.: 16/051,169

(22) Filed: Jul. 31, 2018

(51) Int. Cl. H04N 21/472; H04N 21/6587; H04N 21/4782; H04N 21/81; G06F 3/0484

(52) U.S. Cl. CPC H04N 21/47217; H04N 21/6587; G06F 3/04845; H04N 21/8173; H04N 21/4782

(57) ABSTRACT

In an example, a processor may render one or more displays of a user interaction window based on navigation through logical pages of a web-based application, the one or more displays including a plurality of controls comprising at least one navigation control to control the navigation and one or more video playback controls to initiate playback of one or more videos, respectively, in a playback window. The processor may continue a playback of one of the one or more videos using the playback window through navigation through the logical pages using the at least one navigation control and/or may launch an additional video of the one or more videos at a same playback window size/position associated with a previous playback.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD

One or more implementations relate generally to web-based applications, and some embodiments relate to video playback in a web-based application using a resizable and repositionable window.

### DESCRIPTION OF THE RELATED ART

Analytics is hard complex concepts and sophisticated models make it challenging for those without an analytics background to learn quickly. Additionally, in an attempt to simplify complex processes and remove coding requirements for non-developer users, analytic tools may involve user interfaces for designing data flows or visualizations to uncover insights in the data. These tools may be highly visual, and some users may struggle to learn how to use them with just documentation alone. As a result, video tutorials have become a popular help tool for analytics applications especially, but also other applications.

Video help for a web application (e.g., a client run in a browser) may be delivered separately from the product experience. For instance, video help for the web application may be embedded in a product website or provided by a third party site, such as YouTube®. In either case, users may be required to open two browser tabs—one for the web application and the other for the product website or the third party website. A user may have to switch between browser tabs as they try to watch the video help in one browser tab, and then apply what they have learned in the web application open in the other browser tab.

### BRIEF DESCRIPTION OF THE DRAWINGS

The included drawings are for illustrative purposes and serve to provide examples of possible structures and operations for the disclosed inventive systems, apparatus, methods and computer-readable storage media. These drawings in no way limit any changes in form and detail that may be made by one skilled in the art without departing from the spirit and scope of the disclosed implementations.

FIG. 1A shows a block diagram of an example environment in which an on-demand database service can be used according to some implementations.

FIG. 1B shows a block diagram of example implementations of elements of FIG. 1A and example interconnections between these elements according to some implementations.

FIG. 2 is a block diagram illustrating video playback in a web-based application using a resizable and repositionable window.

FIG. 3 is a flow diagram illustrating operations for video playback in a web-based application using a resizable and repositionable window.

FIG. 4 is a block diagram illustrating a node hierarchy of a web page in a single page application (SPA) embodiment for any web-based application described herein.

### DETAILED DESCRIPTION

Examples of systems, apparatus, computer-readable storage media, and methods according to the disclosed implementations are described in this section. These examples are being provided solely to add context and aid in the understanding of the disclosed implementations. It will thus be apparent to one skilled in the art that the disclosed implementations may be practiced without some or all of the specific details provided. In other instances, certain process or method operations also referred to herein as “blocks,” have not been described in detail in order to avoid unnecessarily obscuring the disclosed implementations. Other implementations and applications also are possible, and as such, the following examples should not be taken as definitive or limiting either in scope or setting.

In the following detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A, B or C” is intended to include the possibilities of “A,” “B,” “C,” “A and B,” “B and C,” “A and C” and “A, B and C.”

Some possible options to delivering video help for a web-based application using two browser tabs may include displaying the video help using a static HTML element iframe, using a static widget, and/or locked to context. However, if a static HTML element iframe is used to display the video help, the static HTML element iframe may block the product experience when the video plays (a user may have to close or minimize the static HTML element iframe in order to apply what they have learned in the web-based application). If a static widget is used to display the video, the user may not have the option view the video at their preferred size and/or at their preferred location on the screen.

If the video help is locked to context, the video player may launch and persist at the point which it was launched. If the user navigates within the web-application, say across different web pages of the web-based application, the video may not travel with them (even if the content within the video guides the user to navigate away from a current web page).

Some product video players may open in an HTML element iframe, and the video player may have a locked aspect ratio. Some product video players may grey out a product screen preventing product interaction while the video plays. Some webpage advertisements or hosting sites such as YouTube, may provide a small frame where a video plays with an option for the user to expand to full screen. The user interface may not provide adjustability of the size of the video outside large/full screen or small. Some providers of in-application video help may provide an in-context link that opens a video player in another browser tab such as YouTube, or their own URL for hosting video content. Users (e.g., analytics users) would benefit from a resizable and repositionable video player to deliver contextually relevant guided learning material within the context of the product experience, and persistently across the product experience (accompanying the user as they navigate across logical pages of a web-based application).

Some implementations described and referenced herein are directed to systems, apparatus, computer-implemented methods and computer-readable storage media for video playback in a web-based application using a resizable and repositionable window. Some embodiments may include a contextual, repositionable (e.g., draggable), resizable video player for training purposes. In some embodiments, the training may relate to a multi-tenant, analytical environment.

Some embodiments may provide users with a user interface to launch a video tutorial from within a product experience, adjust a video player frame for the video tutorial to their preferred viewing size, and drag the video player around the product screen all without losing video player functionality. Additionally, the user interface may allow the user to interact with the product while watching the video without disrupting the video state (e.g., the video may continue to play as the user clicks around the product allowing a user to follow step-by-step instructions alongside the video tutorial). The video player may persist and the video may continue to play even as the user navigates between logical pages of the product experience, allowing the user to follow along with a guided learning experience that may require traversing multiple product states. The video player may change states (e.g., resize/open/close) and the video may change states (e.g., play/pause/rewind/resume/fast forward) only upon the user's action, allowing the user to experience and engage within in-context, video learning material in an uninterrupted manner.

Some embodiments may use a playback window (e.g., a popup, a floating window, a modal window, a palette window, or the like, or combinations thereof) to display video so that the user may view the video content at the size they prefer within a product experience (such as an analytical product experience). Additionally, because the user may interact with the product experience while watching the video, the ability to drag the video player without disrupting the play-state of the video may ensure that no part of the product that the user wants to interact with is ever blocked by the playback window. The ability for the video player to persist while the user traverses across product states may provide an uninterrupted learning experience for the user.

### I. Example System Overview

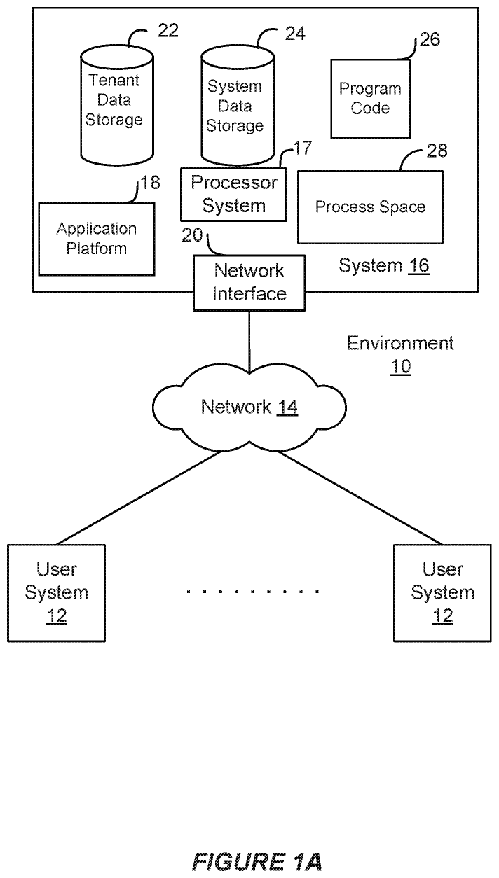

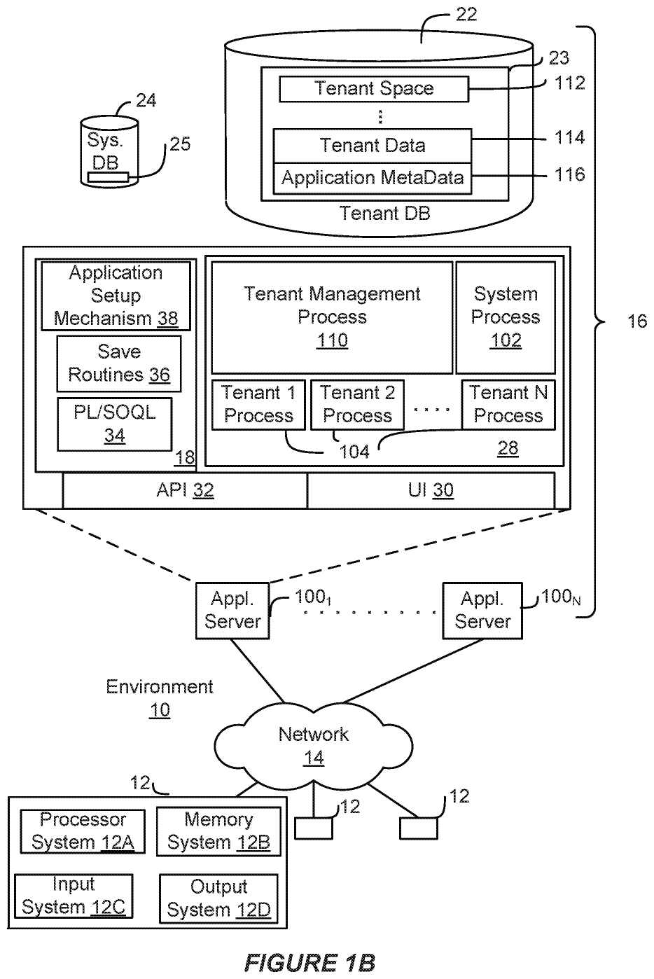

FIG. 1A shows a block diagram of an example of an environment 10 in which an on-demand database service can be used in accordance with some implementations. The environment 10 includes user systems 12, a network 14, a database system 16 (also referred to herein as a “cloud-based system”), a processor system 17, an application platform 18, a network interface 20, tenant database 22 for storing tenant data 23, system database 24 for storing system data 25, program code 26 for implementing various functions of the system 16, and process space 28 for executing database system processes and tenant-specific processes, such as running applications as part of an application hosting service. In some other implementations, environment 10 may not have all of these components or systems, or may have other components or systems instead of, or in addition to, those listed above.

In some implementations, the environment 10 is an environment in which an on-demand database service exists. An on-demand database service, such as that which can be implemented using the system 16, is a service that is made available to users outside of the enterprise(s) that own, maintain or provide access to the system 16. As described above, such users generally do not need to be concerned with building or maintaining the system 16. Instead, resources provided by the system 16 may be available for such users' use when the users need services provided by the system 16; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 18 can be a framework that allows the applications of system 16 to execute, such as the hardware or software infrastructure of the system 16. In some implementations, the application platform 18 enables the creation, management and execution of one or more applications developed by the provider of the on-demand database service, users accessing the on-demand database service via user systems 12, or third party application developers accessing the on-demand database service via user systems 12.

In some implementations, the system 16 implements a web-based customer relationship management (CRM) system. For example, in some such implementations, the system 16 includes application servers configured to implement and execute CRM software applications as well as provide related data, code, forms, renderable web pages and documents and other information to and from user systems 12 and to store to, and retrieve from, a database system related data, objects, and Web page content. In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. The system 16 also implements applications other than, or in addition to, a CRM application. For example, the system 16 can provide tenant access to multiple hosted (standard and custom) applications, including a CRM application. User (or third party developer) applications, which may or may not include CRM, may be supported by the application platform 18. The application platform 18 manages the creation and storage of the applications into one or more database objects and the execution of the applications in one or more virtual machines in the process space of the system 16.

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 14 can be or include any network or combination of networks of systems or devices that communicate with one another. For example, the network 14 can be or include any one or any combination of a LAN (local area network), WAN (wide area network), telephone network, wireless network, cellular network, point-to-point network, star network, token ring network, hub network, or other appropriate configuration. The network 14 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 12 can communicate with system 16 using TCP/IP and, at a higher network level, other common Internet protocols to communicate, such as HTTP, FTP, AFS, WAP, etc. In an example where HTTP is used, each user system 12 can include an HTTP client commonly referred to as a “web browser” or simply a “browser” for sending and receiving HTTP signals to and from an HTTP server of the system 16. Such an HTTP server can be implemented as the sole network interface 20 between the system 16 and the network 14, but other techniques can be used in addition to or instead of these techniques. In some implementations, the network interface 20 between the system 16 and the network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 12 can be implemented as any computing device(s) or other data processing apparatus or systems usable by users to access the database system 16. For example, any of user systems 12 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 12 typically executes an HTTP client, for example, a web browsing (or simply “browsing”) program, such as a web browser based on the WebKit platform, Microsoft's Internet Explorer browser, Apple's Safari, Google's Chrome, Opera's browser, or Mozilla's Firefox browser, or the like, allowing a user (for example, a subscriber of on-demand services provided by the system 16) of the user system 12 to access, process and view information, pages and applications available to it from the system 16 over the network 14.

Each user system 12 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 12 in conjunction with pages, forms, applications and other information provided by the system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 12 can be entirely determined by permissions (permission levels) for the current user of such user system. For example, where a salesperson is using a particular user system 12 to interact with the system 16, that user system can have the capacities allotted to the salesperson. However, while an administrator is using that user system 12 to interact with the system 16, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 12 and some or all of its components are operator-configurable using applications, such as a browser, including computer code executed using a central processing unit (CPU) such as an Intel Pentium® processor or the like. Similarly, the system 16 (and additional instances of an MTS, where more than one is present) and all of its components can be operator-configurable using application(s) including computer code to run using the processor system 17, which may be implemented to include a CPU, which may include an Intel Pentium® processor or the like, or multiple CPUs.

The system 16 includes tangible computer-readable media having non-transitory instructions stored thereon/in that are executable by or used to program a server or other computing system (or collection of such servers or computing systems) to perform some of the implementation of processes described herein. For example, computer program code 26 can implement instructions for operating and configuring the system 16 to intercommunicate and to process web pages, applications and other data and media content as described herein. In some implementations, the computer code 26 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

FIG. 1B shows a block diagram of example implementations of elements of FIG. 1A and example interconnections between these elements according to some implementations. That is, FIG. 1B also illustrates environment 10, but FIG. 1B, various elements of the system 16 and various interconnections between such elements are shown with more specificity according to some more specific implementations. Additionally, in FIG. 1B, the user system 12 includes a processor system 12A, a memory system 12B, an input system 12C, and an output system 12D. The processor system 12A can include any suitable combination of one or more processors. The memory system 12B can include any suitable combination of one or more memory devices. The input system 12C can include any suitable combination of input devices, such as one or more touchscreen interfaces, keyboards, mice, trackballs, scanners, cameras, or interfaces to networks. The output system 12D can include any suitable combination of output devices, such as one or more display devices, printers, or interfaces to networks.

In FIG. 1B, the network interface 20 is implemented as a set of HTTP application servers 100₁-100_{N}. Each application server 100, also referred to herein as an “app server”, is configured to communicate with tenant database 22 and the tenant data 23 therein, as well as system database 24 and the system data 25 therein, to serve requests received from the user systems 12. The tenant data 23 can be divided into individual tenant storage spaces 112, which can be physically or logically arranged or divided. Within each tenant storage space 112, user storage 114 and application metadata 116 can similarly be allocated for each user. For example, a copy of a user's most recently used (MRU) items can be stored to user storage 114. Similarly, a copy of MRU items for an entire organization that is a tenant can be stored to tenant storage space 112.

The process space 28 includes system process space 102, individual tenant process spaces 104 and a tenant management process space 110. The application platform 18 includes an application setup mechanism 38 that supports application developers' creation and management of applications. Such applications and others can be saved as metadata into tenant database 22 by save routines 36 for execution by subscribers as one or more tenant process spaces 104 managed by tenant management process 110, for example. Invocations to such applications can be coded using PL/SOQL 34, which provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications can be detected by one or more system processes, which manage retrieving application metadata 116 for the subscriber making the invocation and executing the metadata as an application in a virtual machine.

The system 16 of FIG. 1B also includes a user interface (UI) 30 and an application programming interface (API) 32 to system 16 resident processes to users or developers at user systems 12. In some other implementations, the environment 10 may not have the same elements as those listed above or may have other elements instead of, or in addition to, those listed above.

Each application server 100 can be communicably coupled with tenant database 22 and system database 24, for example, having access to tenant data 23 and system data 25, respectively, via a different network connection. For example, one application server 100₁ can be coupled via the network 14 (for example, the Internet), another application server 100_{N-1} can be coupled via a direct network link, and another application server 100_{N} can be coupled by yet a different network connection. Transfer Control Protocol and Internet Protocol (TCP/IP) are examples of typical protocols that can be used for communicating between application servers 100 and the system 16. However, it will be apparent to one skilled in the art that other transport protocols can be used to optimize the system 16 depending on the network interconnections used.

In some implementations, each application server 100 is configured to handle requests for any user associated with any organization that is a tenant of the system 16. Because it can be desirable to be able to add and remove application servers 100 from the server pool at any time and for various reasons, in some implementations there is no server affinity for a user or organization to a specific application server 100. In some such implementations, an interface system implementing a load balancing function (for example, an F5 Big-IP load balancer) is communicably coupled between the application servers 100 and the user systems 12 to distribute requests to the application servers 100. In one implementation, the load balancer uses a least-connections algorithm to route user requests to the application servers 100. Other examples of load balancing algorithms, such as round robin and observed-response-time, also can be used. For example, in some instances, three consecutive requests from the same user could hit three different application servers 100, and three requests from different users could hit the same application server 100. In this manner, by way of example, system 16 can be a multi-tenant system in which system 16 handles storage of, and access to, different objects, data and applications across disparate users and organizations.

In one example storage use case, one tenant can be a company that employs a sales force where each salesperson uses system 16 to manage aspects of their sales. A user can maintain contact data, leads data, customer follow-up data, performance data, goals and progress data, etc., all applicable to that user's personal sales process (for example, in tenant database 22). In an example of a MTS arrangement, because all of the data and the applications to access, view, modify, report, transmit, calculate, etc., can be maintained and accessed by a user system 12 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 16 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 16 also can maintain system level data usable by multiple tenants or other data. Such system level data can include industry reports, news, postings, and the like that are sharable among tenants.

In some implementations, the user systems (which also can be client systems) communicate with the application servers 100 to request and update system-level and tenant-level data from the system 16. Such requests and updates can involve sending one or more queries to tenant database 22 or system database 24. The system 16 (for example, an application server 100 in the system 16) can automatically generate one or more SQL statements (for example, one or more SQL queries) designed to access the desired information. System database 24 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

### II. Video Playback in a Web-Based Application Using a Resizable and Repositionable Window

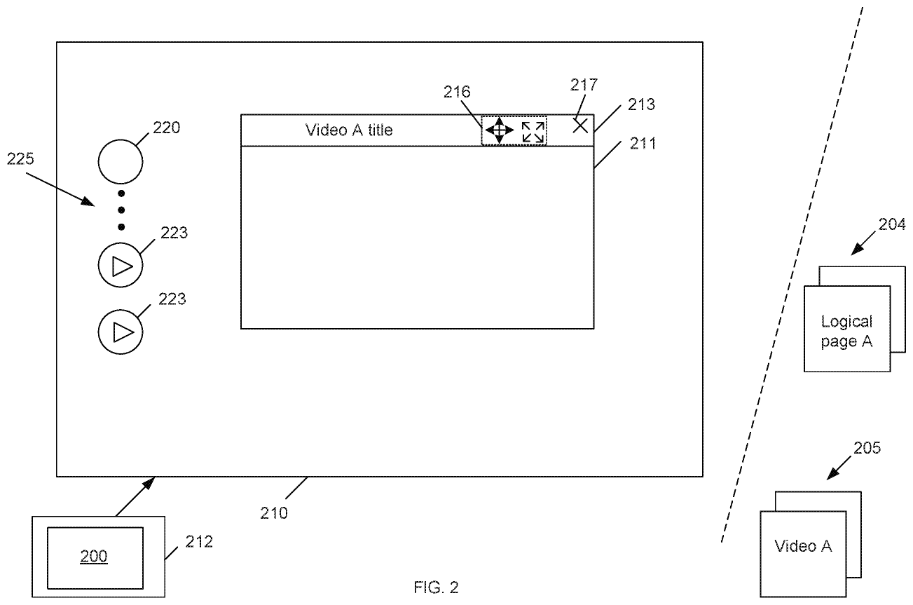

FIG. 2 is a block diagram illustrating video playback in a web-application 200 using a resizable and repositionable window 211. In some examples, the web-based application 200 may be a browser application operated using a web browser of the user terminal, while in other embodiments web-based application 200 may be a native application (e.g., to operate without requiring a web browser).

In some examples, the user terminal 212 may be similar in any respect to the user system 12 described with reference to FIGS. 1A-B, and in some examples the user terminal 212 may download the web-based application 200 from an application server 100_{1-N} described with reference to FIGS. 1A-B. In other examples, the user terminal 212 may include any user system to communicate with any remote system (multi-tenant or otherwise) to download and/or operate the web-based application 200.

A set of videos 205 may be stored on the remote system, or some other remote system. In some examples, at least some videos of the videos 205 may be provided on a data store operated by a hosting site, such as YouTube. The videos 205 may be associated with different logical pages 204 of the web-based application 200. For instance, the videos 205 may be video tutorials each corresponding to a different feature of the logical pages 204. One video, say video A of videos 205, may include video tutorial content to teach a user about features of one or more of the logical pages (e.g., a feature of logical page A). One or more other ones of the videos 205 may include video tutorial content to teach the user about features of the same or other one or more ones of the logical pages 205.

In some embodiments, the web-based application 200 may be a single page application (SPA). In these embodiments, one of the logical pages 204 may correspond with a first location hash of a web page, and another one of the logical pages 204 may correspond with a second different location hash of a same web page. In the embodiments, it may be possible and practical for the web-based application 200 to be any other kind of application—the web-based application 200 need not necessarily be an SPA.

The web-based application 200 may be configured to render one or more displays of a user interaction window 210 based on navigation through the logical pages 204. The one or more displays of the user interaction window 210 may include controls 225, which may include a set of video playback controls 223 and any number of navigation controls 220. In some examples, the navigation controls 200 may include forward, backward, home, or other controls to navigate through the logical pages 204. In examples in which the web-based application 200 is an analytics application, the navigation controls 200 may include controls such as apps, dashboards, lenses, datasets, notifications, shared by me, shared by others, or the like, or combinations thereof.

Each video playback control 223 may launch a different one of the videos 205. Each video playback control 223 may be a graphical user interface (GUI), and may include a play video graphic as illustrated. Each video playback control 223 may be positioned near (e.g., to the right of, to the left of, above, or below, etc.) associated content of the logical pages 204. For example, in an analytics example, a video playback control 223 to initiate a video 205 for guided learning of a user interface for designing data flows may be presented on some or all of the logical pages 204 having the user interface for designing data flows, proximate (say, to the right of) each such user interface. Another video playback control 223 to initiate a different one of the videos 205 for guided learning of a different feature, say for guided learning of a visualization user interface to uncover insights in the data, may be presented on the same or other logical pages 204, proximate (say, to the right of) each such visualization user interface.

The web-based application 200 may render the window 211 over at least one of the displays of the user interaction window 210. In some embodiments, the web-based application 200 may not render the window 211 unless/until at least one of the video playback controls 223 is activated. The web-based application 200 may launch the corresponding video 205 using the window 211. The window 211 may include a header 213 to display a title of the currently playing video.

The window 211 may include a resin and reposition control 216. In some embodiments, a pointer may be placed over an edge or corner of the window 211 to resize the window 211 by clicking on the edge or corner and dragging it to make the window 211 smaller or larger. In some examples, the window 211 may preserve an aspect ratio of the content on a resize. To reposition the window 211, in some embodiments a pointer may be placed on any location of the header 213 to move the window 211 around by click and drag. The window 211 may include a number of other controls 217, say, a control to close the window 211, to pause video playback, resume video playback, or any other control used in video players.

The window 211 may persist the playback of the one of the videos 205 through any navigation between the logical pages 204 based on user inputs to any navigation control 220 of the controls 225. In one example, the video playback may guide the user to activate various navigation controls 220 to move between logical pages 204 for guided learning of the web-based application 200. However, the video playback may persist as the user navigates through the logical pages 204.

After the initial activation of any of the video playback controls 223, the web-based application 200 may receive another user input (e.g., a next activation of any one of the video playback controls 223). The window 211 may play the next video 205, but preserve the state of the window 211. In other words, the web-based application 200 may launch the next video 205 without reverting to a default size/position of the window 211, e.g., may preserve the state represented by resizing/reposition done by the user to the window 211 prior to the next activation of the playback controls 223.

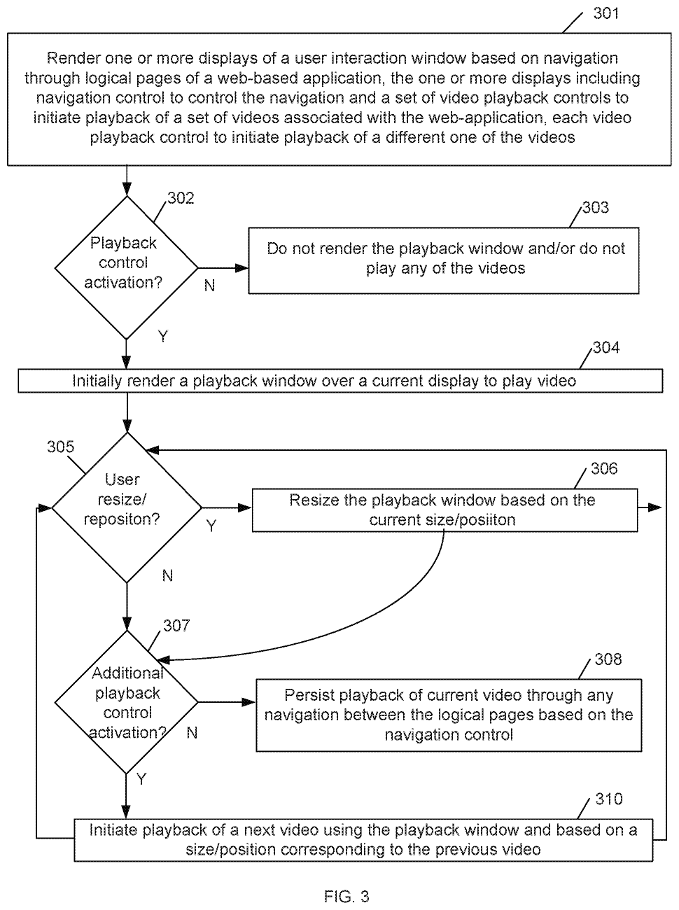

FIG. 3 is a flow diagram illustrating operations for video playback in a web-based application using a resizable and repositionable window. Any processing system described herein (e.g., a processing system of user terminal 212 of FIG. 2) may be configured to execute instructions for video playback in a web-based application using a resizable and repositionable window. The processing system may perform the operations shown in FIG. 3 in response to executing the instructions.

In block 301, the processing system may render one or more displays of a user interaction window based on navigation through logical pages of a web-based application. The one or more displays may include navigation control to control the navigation and a set of video playback controls to initiate playback of a set of videos associated with the web-based application. Each video playback control may initiate a different one of the videos.

If a playback control is activated in diamond 302, then in block 304 the processing system may initially render a playback window over a current display of the user interaction window to play the video. If no playback control is activated, the processing system may not render the playback window and/or not play any of the videos in block 303. If a user resize/reposition is identified in diamond 305, then in block 306 the processing system may resize/reposition the playback window based on the current size/position.

If an additional playback control activation occurs in diamond 307, then in block 310 the processing system may initiate playback of the corresponding video using the playback window and based on a previous size/position if no additional playback control activation occurs, then in block 308 the processing system may persist playback of the current video through any navigation between the logical pages based on the navigation control.

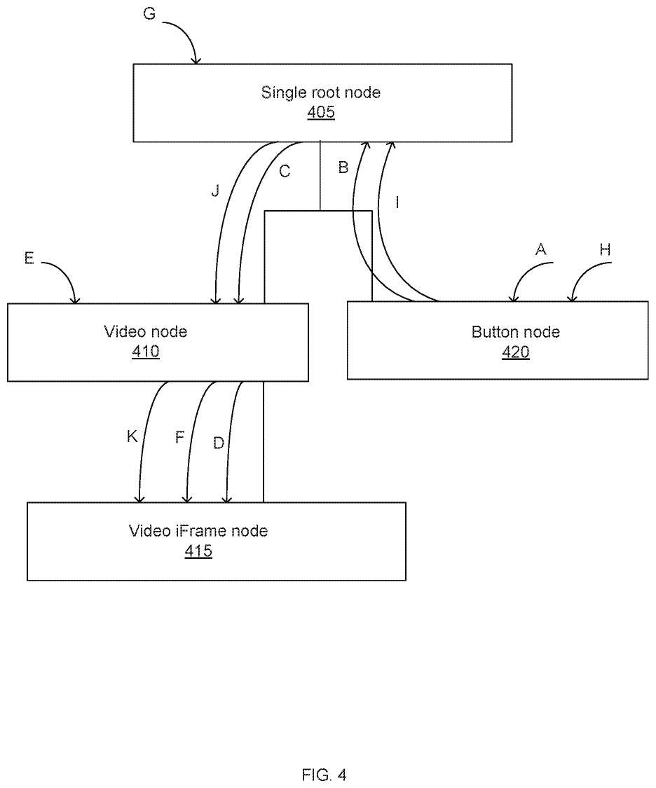

FIG. 4 is a block diagram illustrating a node hierarchy of a web page in a single page application (SPA) embodiment for any web-based application described herein. In some embodiments, a web browser of any user terminal described herein may retrieve a web-based application in a single page load. The web browser may execute JavaScript or some other instructions obtained via the single page load to instantiate one or more nodes.

A single root component may contain the entire web-based application in a single web page. The single root component may expose an operation called showVideo to all of its child components, which may invoke the showVideo operation to launch or update a new video. The showVideo operation may take three arguments: videoold (the ID of the video on the platform it may be hosted), videoTitle (the text that may appear in a header of the playback window) and videoType (may indicate the platform that hosts the video). The showVideo operation may be bound to a click handler or any element such as a button link, text or icon.

A setting of the iFrame (video format e.g., a CSS (cascading style sheets) setting, may be equal to a fixed width 100% and fixed height 100%. However, the iFrame may be embedded in the playback window, and it is the playback window that may be resizable and repositionable. This arrangement may preserve initial aspect ratio through a resizing/repositioning.

The node hierarchy may include single root node 405, video node 410, video iFrame node 415, and button 420. Root node 405 may be the single parent to a tree of child components that include the entire application hierarchy. All application views may be updated by the root node 405 without refreshing the web page. This may allow the video node 410 to preserve its context as the user navigations through the web-based application. Each node may be an HTML element of a DOM (document object model) tree structure, and the root node 405 may be a DOM node).

Video node 410 may be contained in the root component. Video node 410 may be triggered by the showVideo operation (which may be exposed to all child nodes that descend from the root node 405 through a shared context). A video component associated with the video node 410 may be resizable and repositionable while maintaining initial aspect ratio.

The video iFrame node 415 may be the child of the video node 410. Video iFrame node 415 may render the video as an embedded page within the application. Video iFrame node 415 may scale video to fit the width and height of its parent (video node 410) as the video component is resized/repositioned.

One or more button nodes 420 (only one is illustrated for brevity) may correspond to each of the video playback controls (223, FIG. 2). The button node 420 may invoke a single instance of the showVideo operation. This may cause only one video to play at a time, and may cause a new video to replace an existing video at a same size position.

When a user activates a video playback button to launch a video (operation A), the button node 420 may invoke showVideo as illustrated by operation B. The showVideo operation may launch the video component as illustrated by operation C. The video component may render an iFrame with embedded video as indicated by operation D.

When a user repositions/resizes the video component as indicated by operation E, the video component may move and scale video iFrame as indicated by operation F. This may preserve original aspect ratio. When a user navigations through the logical pages of the web-based application as indicated by operation G, the root node 405 may not signal any of the other nodes so that video playback is not affected.

When a user activates a different video playback control to launch a different video as indicated by operation H, the button node 420 may invoke showVideo as illustrated by operation I. The showVideo operation may launch the video component as illustrated by operation J. The video component may render an iFrame with embedded video as indicated by operation K, with the same size/position used with the previous video.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects.

Additionally, while the disclosed examples are often described herein with reference to an implementation in which an on-demand database service environment is implemented in a database system having an application server providing a front end for an on-demand database service capable of supporting multiple tenants, the present implementations are not limited to multi-tenant databases or deployment on application servers. Implementations may be practiced using other database architectures, i.e., ORACLE®, DB2® by IBM and the like without departing from the scope of the implementations claimed.

It should also be understood that some of the disclosed implementations can be embodied in the form of various types of hardware, software, firmware, or combinations thereof, including in the form of control logic, and using such hardware or software in a modular or integrated manner. Other ways or methods are possible using hardware and a combination of hardware and software. Additionally, any of the software components or functions described in this application can be implemented as software code to be executed by one or more processors using any suitable computer language such as, for example, Java, C++ or Perl using, for example, existing or object-oriented techniques. The software code can be stored as a computer- or processor-executable instructions or commands on a physical non-transitory computer-readable medium. Examples of suitable media include random access memory (RAM), read only memory (ROM), magnetic media such as a hard-drive or a floppy disk, or an optical medium such as a compact disk (CD) or DVD (digital versatile disk), flash memory, and the like, or any combination of such storage or transmission devices.

Computer-readable media encoded with the software/program code may be packaged with a compatible device or provided separately from other devices (for example, via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While some implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A user terminal to operate a web-based application, the user terminal comprising:
a processor; and
a memory device coupled to the processor and including instructions stored thereon that, in response to execution by the processor, are operable to perform operations including:
render one or more displays of a user interaction window based on navigation through logical pages of the web-based application, the one or more displays including a plurality of controls comprising at least one navigation control to control the navigation and one or more video playback controls to initiate playback of one or more videos, respectively, in a playback window;
render the playback window over at least one of the displays of the user interaction window, the playback window to persist through any navigation between the logical pages in the user interaction window based on one or more user inputs to the at least one navigation control, wherein the playback window includes a resize control to resize the playback window to a user-selected size and a reposition control to move the playback window relative to the user interaction window to a user-selected location;
in response to a user input to the resize control, render the playback window as specified by the user input to the resize control; and
in response to receipt of a user input to the reposition control, render the playback window positioned as specified by the user input to the reposition control.

2. The user terminal of claim 1, wherein the user input to the resize control or the user input to the reposition control is received at a first time, wherein the operations further comprise:
for an activation of a video playback control of the one or more video playback controls that occurs at a second time that is after the first time, initiate playback of a corresponding one of the one or more videos using the playback window sized or positioned as specified by the user input received at the first time.

3. The user terminal of claim 1, wherein the logical pages are of a same single digital page, and wherein the same single digital page comprises a web page.

4. The user terminal of claim 1, the resize control further to resize the playback window to the user-specified size with content aspect ratio preservation, the reposition control further to reposition the playback window to the user-specified position with the content aspect ratio preservation.

5. The user terminal of claim 1, wherein the operations further comprise render the one or more displays of the user interaction window and the playback window using a web browser.

6. The user terminal of claim 1, wherein at least one of the one or more displays of the user interaction window and the playback window are contemporaneously displayed in a same browser tab of the web browser.

7. A computer readable memory having instructions stored thereon that, in response to execution by a processor, are operable to perform operations including:
render one or more displays of a user interaction window in a web-based application based on navigation through logical pages of the web-based application, the one or more displays including a plurality of controls comprising at least one navigation control to control the navigation and one or more video playback controls to initiate one or more videos, respectively, in a playback window;
render the playback window over a current one of the displays of the user interaction window, the playback window to persist through any navigation between the logical pages in the user interaction window based on one or more user inputs to the at least one navigation control, wherein the playback window includes a resize control to resize the playback window to a user-selected size and a reposition control to move the playback window relative to the user interaction window to a user-selected location;
in response to receipt of a user input to the resize control, render the playback window as specified by the user input to the resize control; and
in response to receipt of a user input to the reposition control, render the playback window as specified by the user input to the reposition control.

8. The computer readable memory of claim 7, wherein the instructions are executable by a web browser.

9. The computer readable memory of claim 7, wherein the operations further comprise:
generate a video format frame to playback the corresponding video; and
embed video format frame in the playback window.

10. The computer readable memory of claim 9, wherein the video format frame is set to fixed height and width.

11. The computer readable memory of claim 10, wherein the video format frame comprises an iFrame.

12. The computer readable memory of claim 11, wherein the iFrame is set to fixed height and width using a CSS (cascading style sheet) setting.

13. The computer readable memory of claim 12, wherein the CSS setting is equal to one hundred percent width and one hundred percent height.

14. A computer-implemented method, comprising:
rendering one or more displays of a user interaction window in a web-based application based on navigation through logical pages of a web-based application, the one or more displays including a plurality of controls comprising at least one navigation control to control the navigation and one or more video playback controls to initiate playback of one or more videos, respectively, in a playback window;
rendering the playback window over one of the displays of the user interaction window, the playback window to persist through any navigation between the logical pages in the user interaction window based on one or more user inputs to the at least one navigation control, wherein the playback window includes a resize control to resize the playback window to a user-selected size and a reposition control to move the payback window relative to the user interaction window to a user-selected location;
in response to receipt of a user input to the resize control, rendering the playback window sized as specified by the user input to the resize control; and
in response to receipt of a user input to the reposition control, rendering the playback window positioned as specified by the user input to the reposition control.

15. The computer-implemented method of claim 14, further comprising displaying the playback window and the one or more displays of the user interaction window in a web browser.

16. The computer-implemented method of claim 15, further comprising simultaneously displaying the playback window and at least one of the one or more displays of the user interaction window in same browser tab of the web browser.

17. The computer-implemented method of claim 16, wherein the user input specifies a reduction to the size of the playback window, and the method further comprises:
generating a video format frame set to max height and max width to embed in the playback window; and
using the video format frame to display the corresponding video in the playback window.

18. The computer-implemented method of claim 14, wherein the user input to the resize control or the user input to the reposition control is received at a first time, wherein the operations further comprise:
for an activation of a video playback control of the one or more video playback controls that occurs at a second time that is after the first time, initiate playback of a corresponding one of the one or more videos using the playback window sized or positioned as specified by the user input received at the first time;
identifying an initial activation of a video playback control of the one or more video playback controls, wherein the initial activation comprises a first activation, wherein the activation at the second time comprises a second non-initial activation of the same or different one of the one or more video playback controls as the first activation; and
initially displaying the playback window in response to the first activation.

19. The computer-implemented method of claim 18, wherein the initial displaying is at a default size and/or position.

20. The computer-implemented method of claim 19, wherein playback window is resizable and/or repositionable from the default size and/or position to expose a view of any arbitrary region of the user interaction window.
